(19) United States
(12) Patent Application Publication
(10) Pub. No.: US 2007/0082694 A1
(43) Pub. Date: Apr. 12, 2007

(54) Wireless communication system with signal received confirmation

(76) Inventor: Nicolas A. Braam, Victoria (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/246,556

(22) Filed: Oct. 7, 2005

(51) Int. Cl. H04M 1/00

(52) U.S. Cl. 455/550.1

(57) ABSTRACT

A wireless communication system, which includes more than one transceiver. Each transceiver having a signal status interface along with a call actuation interface which is adapted to initiate a signal. Upon receiving a signal from a signal originating transceiver, the processor controller is programmed to communicate an alert to facilities personnel and immediately emit a confirmation signal to the signal originating transceiver. The confirmation signal, upon being received by the signal originating portable transceiver, is communicated to a user via the signal status interface, whereby the user is informed that the signal has been received.

### FIELD OF THE INVENTION

The present invention relates to wireless communication systems and, in particular, wireless communication systems used in nursing homes and other health care facilities.

### BACKGROUND OF THE INVENTION

In health care facilities, patients are frequently equipped with a wireless transmitter having a call button. If the patient finds himself or herself in difficulty, health care facility staff can be summoned for assistance by pushing a button on the transmitter. Unfortunately, a common problem with wireless communication systems is that of transmitted signals being missed and staff not being alerted of the patient's need for assistance.

There are a number of reasons why transmitted signals are sometimes not received. Signals can be missed due to interference or the transmitting device being out of range. The transmitters may become damaged or have dead batteries, so the transmitter is no longer capable of sending signals.

### SUMMARY OF THE INVENTION

According to the present invention there is provided a wireless communication system, which includes more than one transceiver. Each transceiver having a signal status interface along with a call actuation interface which is adapted to initiate a signal. The system also includes a processor controller, means for receiving signals from each transceiver that communicates with the processor controller, means for sending signals to each transceiver that is controlled by the processor controller and means for the processor controller to communicate with facilities personnel. Upon receiving communication from the means for receiving signals that a signal has been received from a signal originating transceiver of the more than one transceiver, the processor controller being programmed to communicate an alert to facilities personnel via the means to communicate with facilities personnel and cause the means for sending signals to immediately emit a confirmation signal to the signal originating transceiver; and

the confirmation signal, upon being received by the signal originating portable transceiver, is communicated to a user via the signal status interface, whereby the user is informed that the signal has been received.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a block diagram of a wireless communication system constructed in accordance with the teachings of the present invention.

FIG. 2 is a front perspective view of a portable transceiver used in the wireless communication system illustrated in FIG. 1.

FIG. 3A is a flow chart for the signal response by the wireless communication system illustrated in FIG. 1.

FIG. 4A-4D are circuit diagrams for a portable transceiver used in the wireless communication system illustrated in FIG. 1.

FIG. 5A-5F are circuit diagrams for a wireless server receiver used in the wireless communication system illustrated in FIG. 1.

### DETAILED DESCRIPTION OF THE PREFERRED EMBODIMENT

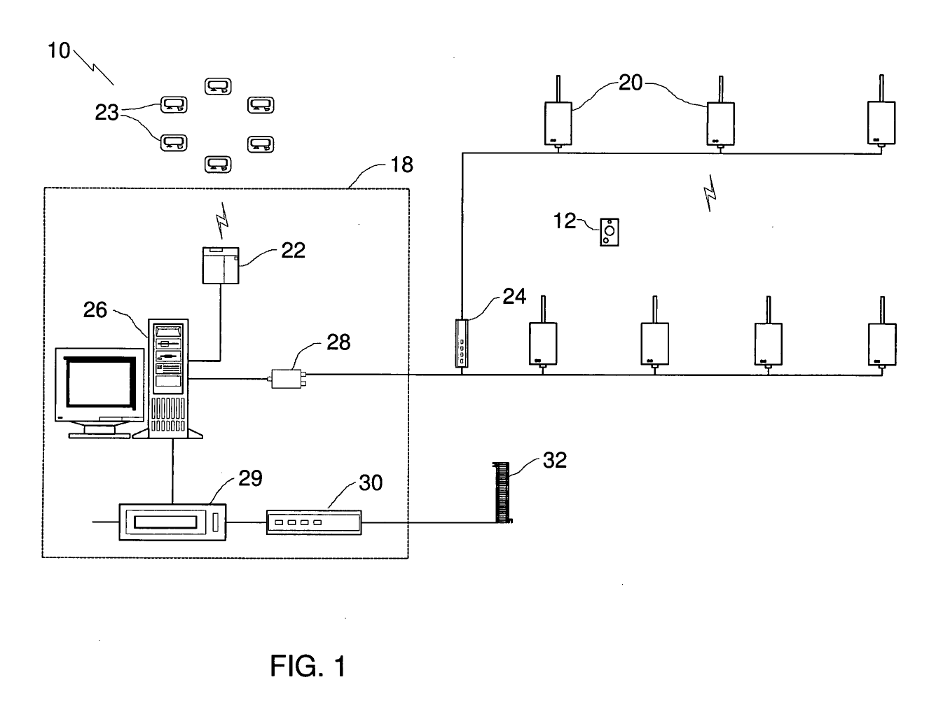

The preferred embodiment, a wireless communication system generally identified by reference numeral 10, will now be described with reference to FIG. 1 through 5.

Structure and Relationship of Parts:

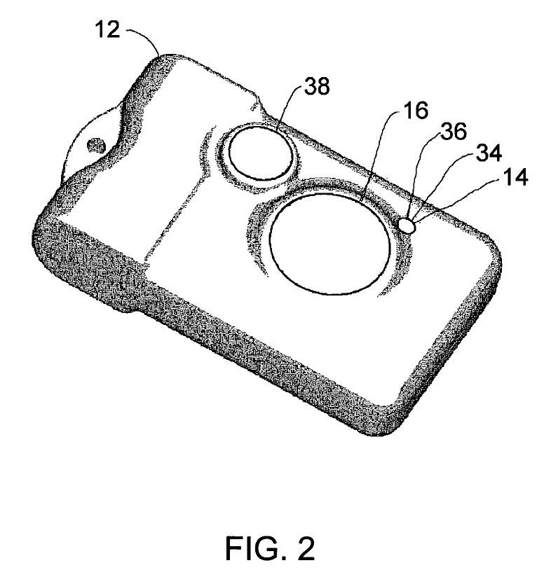

Referring now to FIG. 1, wireless communication system 10 includes multiple portable transceivers 12. Referring to FIG. 2, each portable transceiver 12 is adapted to be carried by a user, and has a signal status interface 14, and a call actuation interface in the form of call button 16. Call button 16 is adapted to initiate a signal. Referring to FIG. 1, wireless communication system 10 also includes a processor controller 18, with multiple wireless receivers 20 and a paging transmitter 22 in communication with processor controller 18. As shown, receivers 20 are connected by a network repeater 24, which is then connected to a base computer 26 through an interface 28. The receivers used with the system are actually transceivers which are capable of giving a return signal upon command from base computer 26, which forms part of the processor controller. Paging transmitter 22 is directly connected to base computer 26, and connected by a wireless connection to remote pagers 23 carried by health care professionals. Base computer 26 is preferably powered using an uninterruptible power source 29, which also powers receivers 20 using, for example, a 24 VDC 20 A power supply 30 and a power distributor 32. Other network architectures may be used, with the number of receivers 20 and paging transmitters 22 being variable.

Referring to FIG. 2, signal status interface 14 may be a visual display 34. Visual display 34 includes a green light, which is illuminated upon the confirmation signal being received, and a red light, which is illuminated should the confirmation signal not be received within a predetermined time interval (a few seconds). As depicted, the green light and the red light are produced by LEDs (not shown) located below a light pipe 36. It will be appreciated that any desired colour can be selected for the lights, as long as their meaning is understood to the use. It will also be appreciated that separate lights can be used or a single multi-coloured LED. Call button 16 is preferably recessed slightly to prevent accidentally sending a signal. In addition, a cancel button 38 is included with which facilities personnel can cancel a request upon attending to the user (patient). In some circumstances, the user may be also use the cancel button to cancel a request that either was sent either accidentally, or is no longer required.

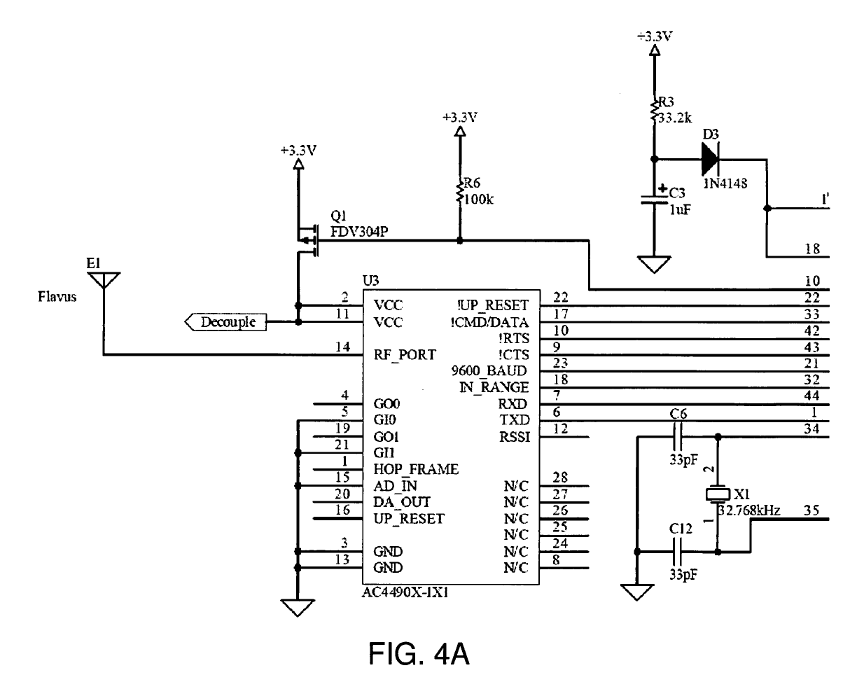

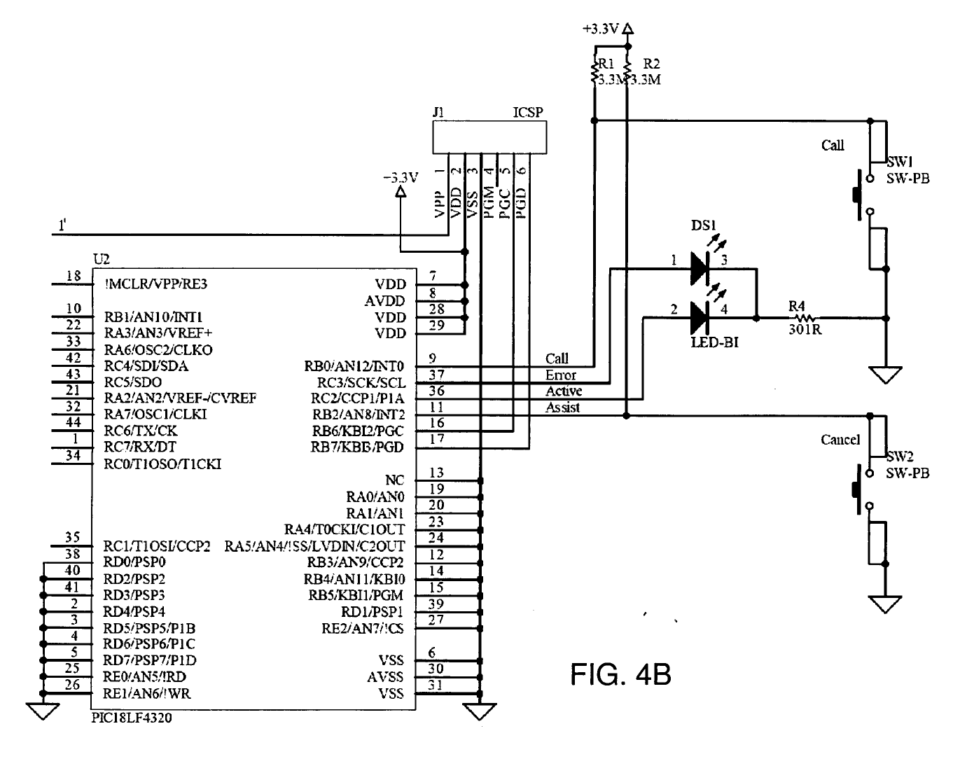

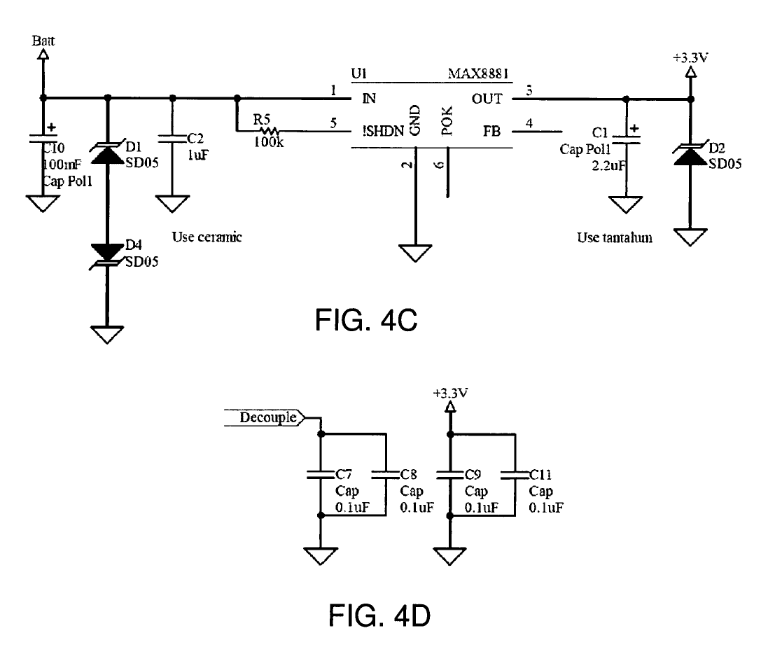

Referring to FIG. 4A through 4D, an example circuit diagram for portable transceiver 12 (FIG. 1.) is shown. Component U4 (FIG. 4A.) is an OEM wireless transceiver used by the portable transceiver 12 for communication in the wireless medium with receiver(s) 20. Component U2 (FIG. 4B.) is a microcontroller which contains program code and controls all operation of the portable transceiver 12. Component DS1 (FIG. 4B.) is the LED (FIG. 2. visual display 34) which creates the green or red confirmation signal. Component SW1 (FIG. 4B.) is a switch (FIG. 2. call button 16) which is pressed by the user to send a call message. Component SW2 (FIG. 4B.) is a switch (FIG. 2. cancel button 38) which is pressed by the user to send a cancel message. All other components within the circuit diagram (FIG. 4A-4D.) are supportive components and their operation is not crucial to operation.

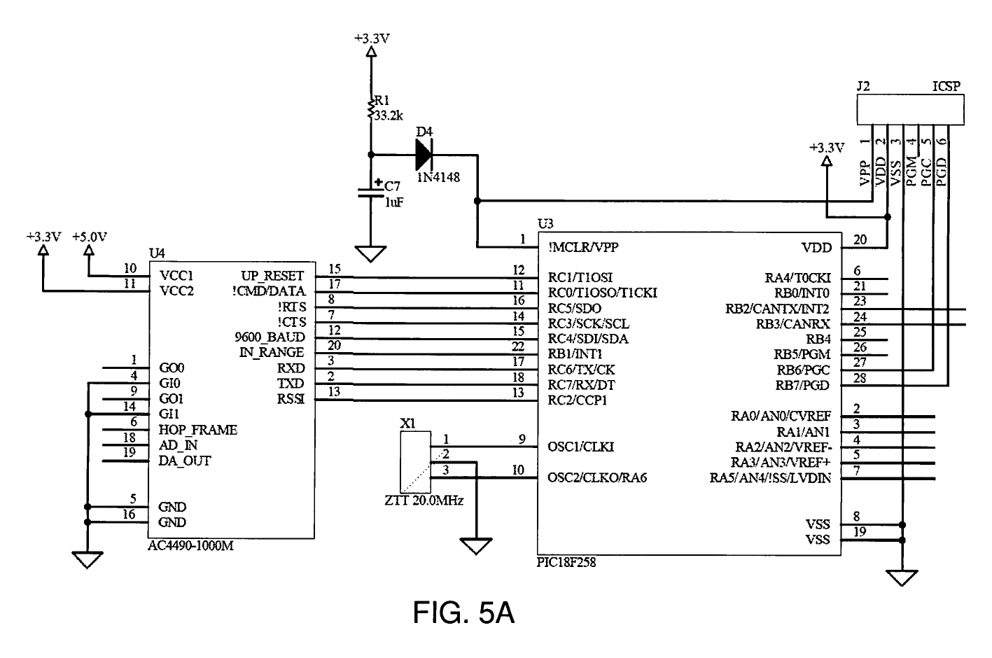

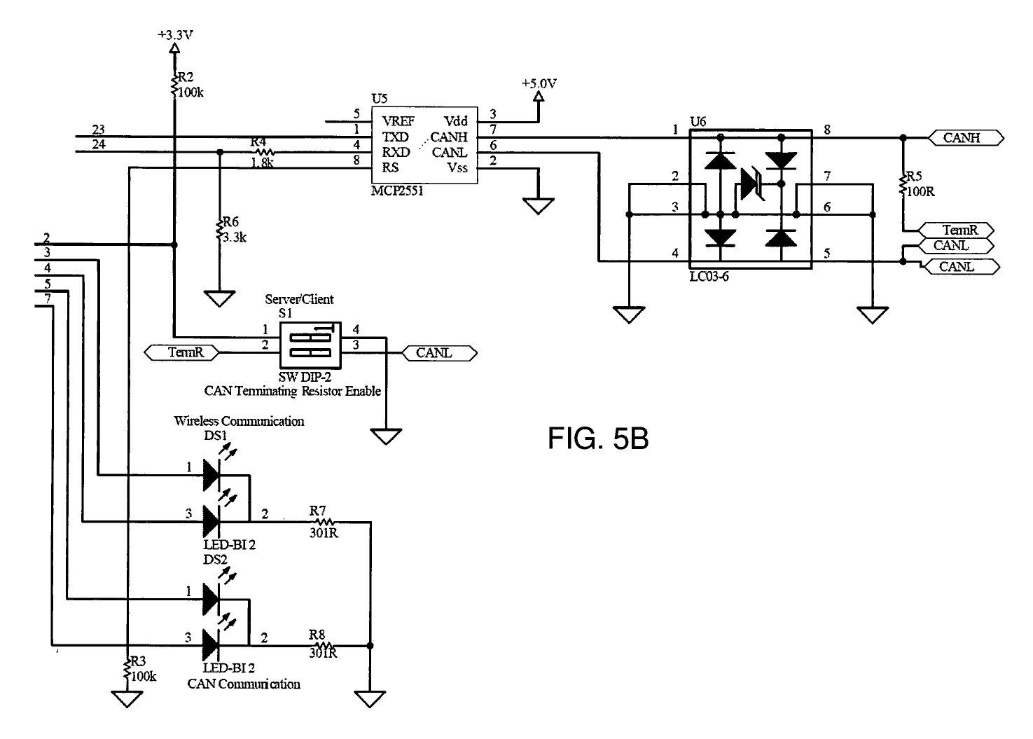

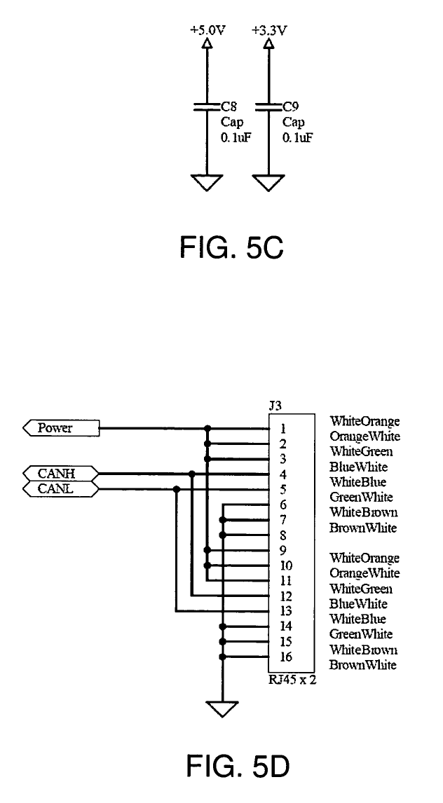

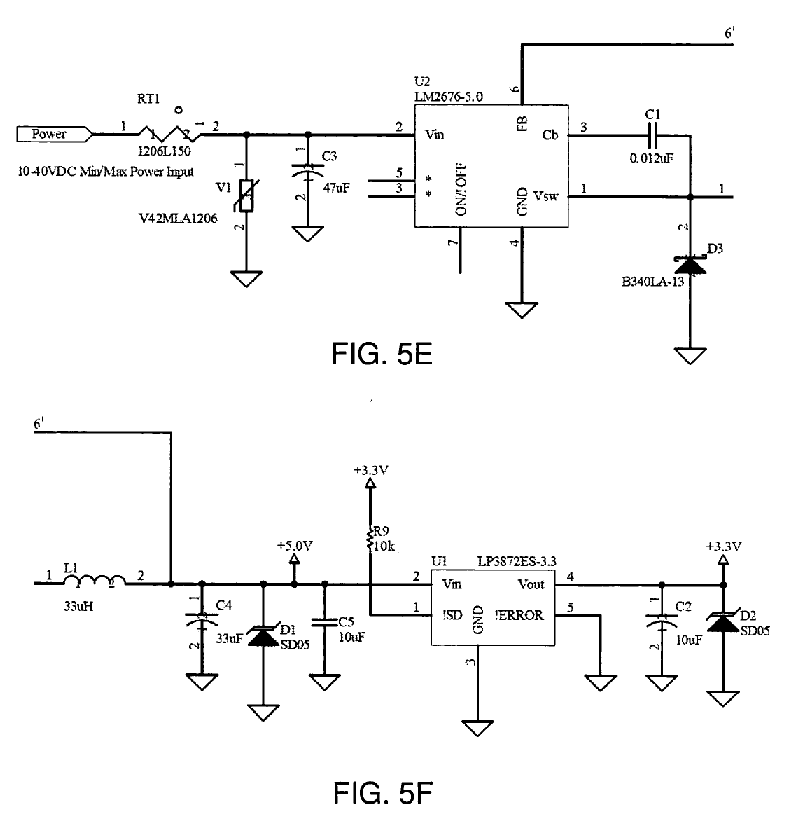

Referring to FIG. 5A through 5F, an example circuit diagram for wireless server receiver 20 (FIG. 1.) is shown. Component U4 (FIG. 5A.) is an OEM wireless transceiver used by the receiver 20 for communication in the wireless medium with portable transceivers 12 (FIG. 1.). Component U3 (FIG. 5A.) is a microcontroller which contains program code and controls all operation of the receiver 20. Components U5, U6 (FIG. 5B.) and J3 (FIG. 5D.) enable the receiver 20 to communicate via a wired medium with the processor controller 18 (FIG. 1.). All other components within the circuit diagram (FIG. 5A-5F.) are supportive components and their operation is not crucial to operation.

Operation

Referring to FIG. 1, wireless communication system 10 is provided as described above. Referring to FIG. 2, call button 16 is depressed, which causes portable transceiver 12 to transmit a request signal. Referring to FIG. 1, this signal is then received by one of the receivers 20. The signal is relayed through the bus network to base computer 26 of processor controller 18. Upon successful delivery of the message to base computer 26 by receiver 20, the receiver 20 will proceed to respond to the signal originating portable transceiver 12 causing it to immediately emit a confirmation signal. Upon receiving communication from receiver 20 that a signal has been received from signal originating portable transceiver 12, base computer 26 is programmed to send an alert to all computers in the network and cause paging transmitter 22 to immediately emit a signal to various pagers 23 to indicate the patient request to the required health care professionals. The confirmation signal, upon being received by signal originating portable transceiver 12, is indicated to the user through signal status interface 14, whereby the user is informed that the signal has been received. Although an audio interface could be used, it is preferred that the interface be visual. Referring to FIG. 2, if a green light is illuminated behind light pipe 36 it indicates to the user that the signal has been received and, presumably, will be acted upon as soon as staff are available. However, if a red light is illuminated behind light pipe 36, it indicates that the signal was not received. The user knows to send another signal and, if possible, move to a position where there is less interference or more closer to be within range.

Each portable transceiver 12 communicates status information within regular pre-determined time periods to base computer 26 via receivers 20. If base computer 26 fails to receive a scheduled status signal from a portable transceiver 12, base computer 26 initiates an alarm condition. Battery status data may also be communicated in the scheduled signal to provide advance warning that battery strength has dropped below a preset threshold in transceiver 12. This allows batteries to be replaced in advance of failure, while portable transceiver 12 is still capable of operation.

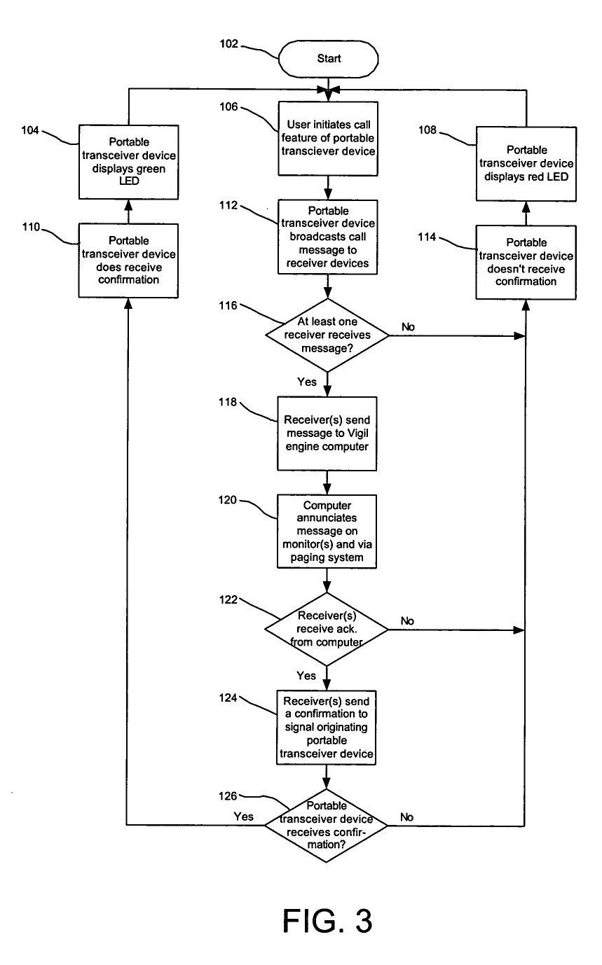

Referring to FIG. 3, an example flow chart depicting the flow of events leading to confirmation signal display. Referring to block 102, Start indicates the set up of the system.

Referring to block 106 of the flow chart, a user initiates a call at a portable transceiver device (FIG. 1. 12) by pressing the call button (FIG. 2. 16). Referring to block 112 of the flow chart, portable transceiver device 12 produces a wireless broadcast message to receivers (FIG. 1. 20). Referring to block 116 of the flow chart, if the wireless signal is sufficient, one or more receivers 20 will receive the said broadcast message. Referring to block 114 and 108, if the wireless message signal fails, portable transceiver device 12 will display message failure to the user by a red LED visual display (FIG. 2. 34). Referring to block 118 of the flowchart, receivers 20 that have received the wireless broadcast successfully will proceed to send the message via the wired medium to the base computer (FIG. 1. 26). Referring to block 120, upon receiving the portable transceiver device 12 originated message, the base computer 26 will annunciate the message on it's monitor and via the paging system (paging transmitter and pagers FIG. 1. 22, 23 respectively). Referring to block 122, the receivers 20 meanwhile will await an acknowledge from the base computer 26. Referring to block 114 and 108, if the receiver(s) 20 and base computer 26 fail to communicate, portable transceiver device 12 will display message failure to the user by a red LED visual display (FIG. 2. 34). Referring to block 124, if the receiver(s) 20 have communicated successfully with the base computer 26, the said receiver(s) 20 will transmit a confirmation message to the original user stimulated portable transceiver device 12. Referring to block 126, the said portable transceiver device 12 will receive the confirmation message if the wireless signal is sufficient. Referring to block 114 and 108, if the wireless confirmation signal fails, portable transceiver device 12 will display message failure to the user by a red LED visual display (FIG. 2. 34). Referring to block 110 and 104, if the wireless confirmation signal is received by portable transceiver 12, the said device will display message success to the user by a green LED visual display (FIG. 2. 34).

The utility of the system will be further explained with reference to examples. In a care facility a crisis can be experienced by a resident or a crisis can be experienced by a staff member. An example of a crisis by a resident, would be a resident having a fall and breaking a hip. An example of a crisis by a staff member, would be a staff member being attacked by a resident exhibiting aggressive tendencies which frequently arise during the advanced stages of dementia. Prior to the development of the present invention there could be two quite different responses, each of which are undesirable. Some users would push the button and assume that the wireless signal had gotten through. This response placed the user at risk if, in fact, the signal had not gotten through. Other users experienced additional stress wondering whether their signal had gotten through and repeatedly pushed the call button until help responded. Of course, if the signal is not getting through, pushing the call button repeatedly does not improve the situation. With the present invention, the user receives immediate notification as to whether or not the signal has gotten through. If the signal has not gotten through, the user can take steps to change position before pushing the button again. The portable transmitter can be demonstrated to the resident at the resident's room by facilities staff. This gives residents confidence, that should the device be required their signal will get through. A failed demonstration alerts facilities personnel as to the need for more receiving transceivers, should they discover that the signals from a patient's room or some area of the facility does not get through.

Variations

This system was developed with portable transceivers in mind, typically in the form of pendants or wrist bands. It will be appreciated that in some facilities, they may chose to use transceivers that are affixed to the wall or are otherwise not “portable”. This system was built using receiving transceivers that can both send and receive signals. It will be appreciated that the signal receiving and signal sending functions can be in separate receivers that communicate signals to the processor controller and transmitters controlled by the processor controller.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A wireless communication system, comprising:
more than one transceiver, each transceiver having a signal status interface along with a call actuation interface which is adapted to initiate a signal;
a processor controller;
means for receiving signals from each transceiver in communication with the processor controller;
means for sending signals to each transceiver controlled by the processor controller;
means for the processor controller to communicate with facilities personnel;
upon receiving communication from the means for receiving signals that a signal has been received from a signal originating transceiver of the more than one transceiver, the processor controller being programmed to communicate an alert to facilities personnel via the means to communicate with facilities personnel and cause the means for sending signals to immediately emit a confirmation signal to the signal originating transceiver; and
the confirmation signal, upon being received by the signal originating portable transceiver, is communicated to a user via the signal status interface, whereby the user is informed that the signal has been received.

2. The wireless communication system as defined in claim 1, wherein each transceiver is portable and is adapted to be carried on a body of the user.

3. The wireless communication system as defined in claim 1, wherein the signal status interface is a visual display.

4. The wireless communication system as defined in claim 3, wherein the visual display has a first colour of light, which is illuminated upon the confirmation signal being received.

5. The wireless communication system as defined in claim 3, wherein the visual display has a second colour of light, which is illuminated should the confirmation signal not be received within a predetermined time interval.

6. The wireless communication system as defined in claim 1, wherein the processor controller awaits scheduled status messages from each portable transceiver, failure of the processor controller to receive, via the means of receiving a signal, a status message from each of the portable transceivers, results in the processor controller initiating an alarm condition.

7. The wireless communication system as defined in claim 6, wherein battery status data is communicated in the signal from the transceiver to provide advance warning that battery strength has dropped below a preset threshold.

8. The wireless communication system as defined in claim 1, wherein the means for receiving signals from each transceiver and the means for sending signals to each transceiver is a receiving transceiver controlled by and in communication with the processor controller.
